(19) United States
(12) Patent Application Publication
(10) Pub. No.: US 2026/0267598 A1
(43) Pub. Date: Sep. 10, 2026

(54) DEVICE CONTROL METHOD AND DEVICE CONTROL APPARATUS

(71) Applicant: YAMAHA CORPORATION, Hamamatsu-shi (JP)

(72) Inventors: Koki HIGASHIHARA, Hamamatsu-shi (JP); Koichiro Sato, Hamamatsu-shi (JP); Takamitsu Aoki, Hamamatsu-shi (JP)

(21) Appl. No.: 19/661,956

(22) Filed: Apr. 29, 2026

Related U.S. Application Data
(63) Continuation of application No. PCT/JP2024/037372, filed on Oct. 21, 2024.

(30) Foreign Application Priority Data
Nov. 6, 2023 (JP) 2023-189170

(51) Int. Cl. G06F 3/16; G06T 7/73

(52) U.S. Cl. CPC G06F 3/165; G06T 7/73

(57) ABSTRACT

An audio device control method includes acquiring an image of an inside of a room including at least one audio device and at least one person; determining, from the acquired image, device position information of an audio device, from among the at least one audio device, and person position information of a person, from among the at least one person; and controlling an operation state of the audio device based on a relation between the device position information and the person position information. The controlling of the operation state includes any among powering ON and OFF the audio device; connecting and disconnecting the audio device to and from the audio control apparatus; and adjusting volume of the audio device.

### CROSS-REFERENCE TO RELATED APPLICATIONS

This is a continuation of International Application No. PCT/JP2024/037372 filed on Oct. 21, 2024, and claims priority from Japanese Patent Application No. 2023-189170 filed on Nov. 6, 2023, the entire content of which is incorporated herein by reference.

### TECHNICAL FIELD

The present disclosure relates to a device control method for controlling a peripheral device using information acquired by a camera in a wireless communication device.

### BACKGROUND ART

In the related art, there is known a device control system that grasps various types of environmental information of an inside of a room and issues a control instruction to a connected indoor device.

Patent Literature 1 discloses a device control apparatus in which various types of environmental situations (presence or absence, the number, position, activity state, figure, and size of person in room, position of object, indoor brightness, security abnormality, fire abnormality, and the like) of an inside of a room are monitored by a camera unit installed on a ceiling or a wall, or a combination of the camera unit and a detection unit configured to detect a temperature or an audio, and indoor information or information processed into a control command based on the indoor information is wirelessly transmitted to an indoor device.

In the related art, there is known a monitoring system in which a camera apparatus and a microphone array apparatus are installed to obtain audio data in a direction in which the camera apparatus captures an image of a specific subject for photography.

Patent Literature 2 discloses an audio processing system and an audio processing method in which an audio collected by a microphone array apparatus is used to emphasize an audio in a specified direction, and then volume of the audio is adjusted to prevent occurrence of a large difference in volume before and after the emphasizing, thereby improving convenience for a user.

### CITATION LIST

### PATENT LITERATURE

Patent Literature 1: JPH07-271426A

Patent Literature 2: JP2016-39407A

### SUMMARY OF INVENTION

The invention of Patent Literature 1 controls the indoor device based on indoor information obtained from an image. In the configuration of Patent Literature 1, the indoor device to be controlled may be installed anywhere, whether within or outside the image, but needs to be connected to the device control apparatus in advance. That is, in the configuration of Patent Literature 1, the image is used to monitor the environmental situations of the inside of the room, and the indoor device to be controlled is not determined based on the image. In addition, in the configuration of Patent Literature 1, it is not assumed that the user freely moves the indoor device, and an installation position of the indoor device cannot be acquired from the image.

An indoor environment disclosed in Patent Literature 1 does not include an acoustic space. Therefore, Patent Literature 1 does not describe a method for controlling an audio signal output from the indoor device based on the indoor information obtained from the image.

In the invention of Patent Literature 2, after receiving an input from a user, a signal processing unit emphasizes the audio in the specified direction using the audio collected by the microphone array apparatus, and adjusts the volume of the audio. In the configuration of Patent Literature 2, in order to acquire audio data in a directivity state, the user needs to manually specify any specified position on an image displayed on a display apparatus. That is, in the configuration of Patent Literature 2, the user himself/herself uses the image to input an operation, and the audio processing system does not automatically output optimum audio data for the user based on the image.

An object of the present disclosure is to provide a device control method capable of automatically controlling a device based on a relation between position information of a device and position information of a user acquired by a camera.

An audio device control method for an audio control apparatus, the method includes acquiring an image, taken by a camera, of an inside of a room including at least one audio device and at least one person; determining, from the acquired image, device position information of an audio device, from among the at least one audio device, and person position information of a person, from among the at least one person; and controlling an operation state of the audio device based on a relation between the device position information and the person position information, wherein the controlling of the operation state includes any among powering ON and OFF the audio device; connecting and disconnecting the audio device to and from the audio control apparatus; and adjusting volume of the audio device.

According to the device control method of the present disclosure, an effect that the device can be automatically controlled based on the relation between the position information of the device and the position information of the user acquired by the camera is achieved.

### BRIEF DESCRIPTION OF DRAWINGS

FIG. 1 is a block diagram illustrating a basic configuration of an information processing system 1;

FIG. 2 is a block diagram illustrating a basic configuration of a data processing apparatus 10;

FIG. 3 is an external perspective view of a room R1 according to a first embodiment;

FIG. 4 is a flowchart illustrating an operation executed by a CPU 11 according to the first embodiment;

FIG. 5 is an example of a flowchart illustrating an operation executed by the CPU 11 according to the first embodiment;

FIG. 6 is an external perspective view of a room R2 according to a second embodiment;

FIG. 7 is a flowchart illustrating an operation executed by the CPU 11 according to the second embodiment;

FIG. 8 is an external perspective view of a room R3 according to a third embodiment;

FIG. 9 is a flowchart illustrating an operation executed by the CPU 11 according to the third embodiment;

FIG. 10 is a plan view of a large conference room R4 according to a fourth embodiment;

FIG. 11 is a plan view of the large conference room R4 according to the fourth embodiment; and

FIG. 12 is a plan view of the large conference room R4 according to the fourth embodiment.

### DESCRIPTION OF EMBODIMENTS

Hereinafter, an information processing system according to an embodiment of the present disclosure will be described with reference to the drawings. In the drawings, the same portions are denoted by the same reference numerals. In a second embodiment and subsequent embodiments, descriptions of matters common to a first embodiment will be omitted, and only differences will be described. In particular, similar operations and effects of similar configurations will not be described in each embodiment.

### First Embodiment

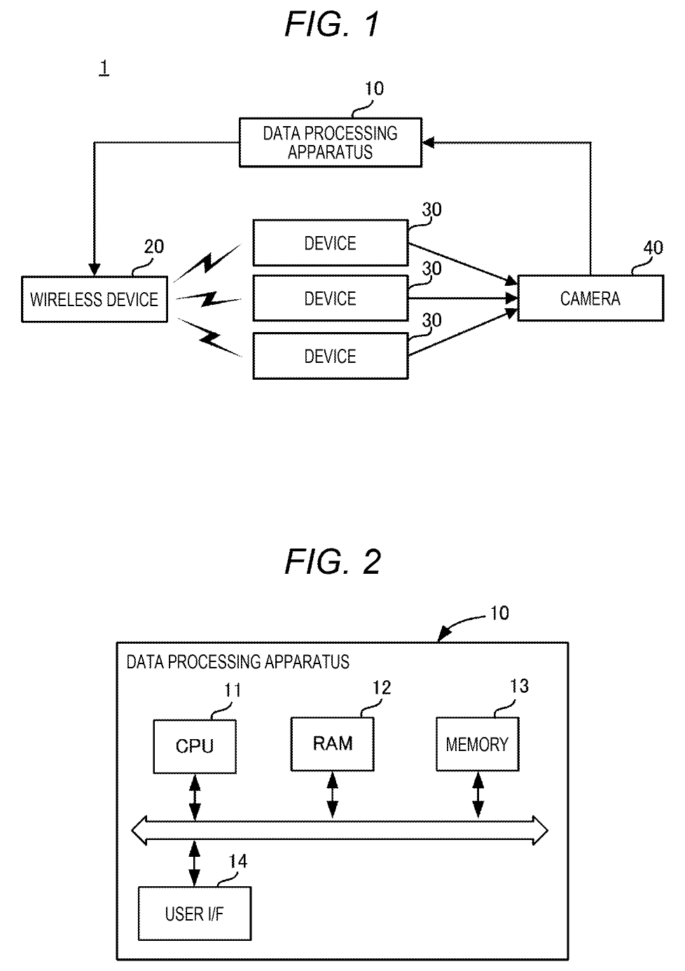

FIG. 1 is a block diagram illustrating a basic configuration of an information processing system 1. The information processing system 1 includes a data processing apparatus 10 such as an audio device control apparatus, a wireless device 20, a device 30 such as an audio device, and a camera 40.

The wireless device 20 is, for example, a signal processing apparatus that receives a sound signal from the device 30 and executes signal processing. Alternatively, the wireless device 20 may be a wireless access point that connects the device 30 to a network. The device 30 is a small desktop microphone. The device 30 may be a small desktop speaker, a large speaker, a personal computer with a microphone speaker built therein, a smartphone, a wearable terminal, or a device capable of recording and reproducing a sound such as music. Hereinafter, these are collectively referred to as the device 30.

In the present disclosure, unless otherwise noted, wireless connection between the wireless device 20 and the device 30 has been completed.

The data processing apparatus 10 is connected to the wireless device 20 and the camera 40. The camera 40 captures an image of a room R1. The camera 40 transmits the captured image to the data processing apparatus 10. The data processing apparatus 10 acquires position information of the device 30 and position information of a user from the image of the room R1 captured by the camera 40.

FIG. 2 is a block diagram illustrating a basic configuration of the data processing apparatus 10. The data processing apparatus 10 includes a CPU 11, a RAM 12, a memory 13, and a user interface (I/F) 14.

The memory 13 stores a program for causing the data processing apparatus 10 to operate. The CPU 11 reads the program stored in the memory 13 into the RAM 12 and controls an operation of the data processing apparatus 10. However, the program does not need to be stored in the memory 13. The CPU 11 may download the program from, for example, a server each time.

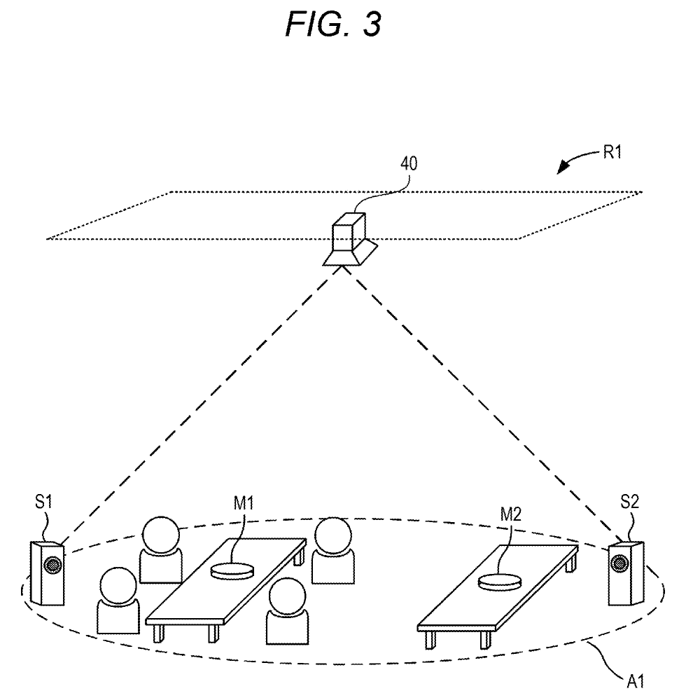

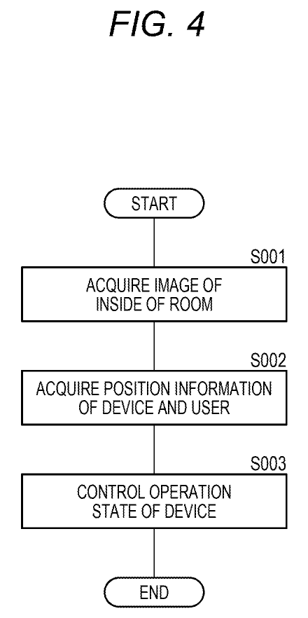

Next, a flow from when the camera 40 captures the image of the room R1 to when the data processing apparatus 10 controls the operation state of the device 30 will be described with reference to FIGS. 3 and 4.

FIG. 3 is an external perspective view of the room R1 according to the first embodiment. In the following description, the room R1 is assumed to be, for example, a conference room, but the room R1 is not limited thereto. Actually, the room R1 may be a hall or a lecture room.

In the present embodiment, the camera 40 installed in the room R1 is, for example, a ceiling camera. The camera 40 is not limited to the ceiling camera, and may be a camera installed on a wall or a camera placed in a conference monitor. The camera 40 may be installed at a position where an image of the device 30 can be captured.

In FIG. 3, an angle of view A1 of the camera 40 is indicated by a broken line. That is, the camera 40 captures an image of a range of the angle of view A1 and transmits the captured image to the data processing apparatus 10. In addition, in the room R1, a speaker S1 and a desktop microphone M1 are installed around the user, and a speaker S2 and a desktop microphone M2 are installed at positions away from the user. In the present embodiment, the speakers S1 and S2 and the desktop microphones M1 and M2 are examples of the device 30 of the present disclosure.

FIG. 4 is a flowchart illustrating an operation executed by the CPU 11 according to the first embodiment. The data processing apparatus 10 acquires the image of the room R1 captured by the camera 40 (S001).

Next, the data processing apparatus 10 acquires the position information of the device 30 and the user based on the image received from the camera 40 (S002). Specifically, the data processing apparatus 10 acquires device information of the device 30 from the acquired image. The device information is information for identifying the device 30. The data processing apparatus 10 acquires the position information of the device 30 based on the acquired device information. The device information is, for example, information related to an appearance shape of a product, and corresponds to model information. The device information may be a two-dimensional barcode, a manufacturer logo, a product logo, an LED lighting pattern, or a barcode.

The position information of the device 30 and the user acquired by the data processing apparatus 10 includes two-dimensional position information. The two-dimensional position information is an X and Y coordinate (orthogonal coordinate) with a predetermined position (for example, lower left) of the image captured by the camera 40 as an origin. Further, the data processing apparatus 10 may further acquire a distance between a position of the device 30 and a position of the user (hereinafter, referred to as device 30-to-user distance) calculated based on the two-dimensional position information as the position information.

Next, the data processing apparatus 10 controls the operation state of the device 30 based on a relation between the position information of the device 30 and the user acquired in step S002 (S003). The data processing apparatus 10 executes, for example, a control to switch the power supply of the device 30 to ON or OFF. The initial power state of the device 30 is set to OFF.

The data processing apparatus 10 may determine whether the device 30-to-user distance is equal to or less than a predetermined value, and execute a control to switch the power supply of the device 30 to ON or OFF based on a determination result.

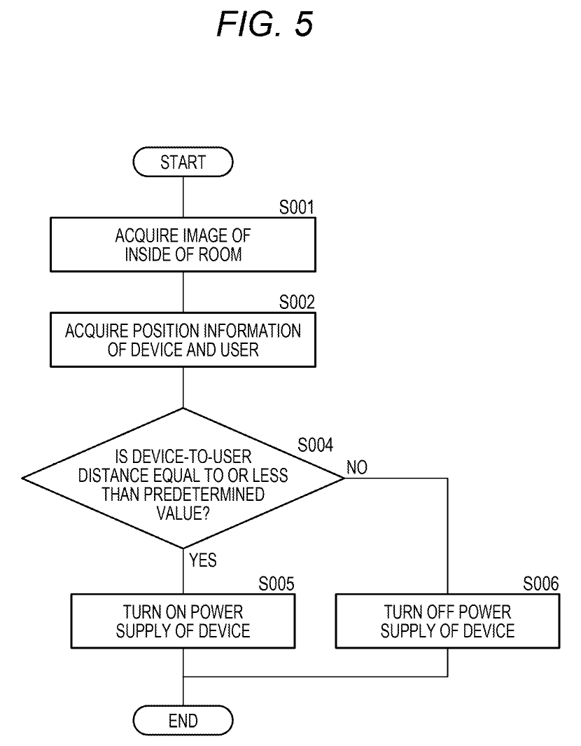

FIG. 5 is an example of a flowchart illustrating an operation executed by the CPU 11 according to the first embodiment. Since processing of steps S001 and S002 in FIG. 5 is the same as processing of steps S001 and S002 in FIG. 4, the description thereof will be omitted.

After acquiring the device 30-to-user distance in step S002, the data processing apparatus 10 determines whether the device 30-to-user distance is equal to or less than the predetermined value (S004).

When it is determined that the device 30-to-user distance is equal to or less than the predetermined value (YES in S004), the data processing apparatus 10 turns on the power supply of the device 30 (S005). When it is determined that the device 30-to-user distance is larger than the predetermined value (NO in S004), the data processing apparatus 10 turns off the power supply of the device 30 (S006).

For example, in the room R1, when it is determined that a distance between the position of the user and a position of the speaker S2 (hereinafter, referred to as user-to-speaker S2 distance) and a distance between the position of the user and a position of the desktop microphone M2 (hereinafter, referred to as user-to-desktop microphone M2 distance) are each larger than the predetermined value, the data processing apparatus 10 issues an instruction to the wireless device 20 to turn off power supplies of the speaker S2 and the desktop microphone M2.

As described above, in the present embodiment, the data processing apparatus 10 controls the operation state of the device 30 based on the relation between the position information of the device 30 and the user. For example, the user can turn on only a power supply of the device 30 desired to be used only by placing the device 30 desired to be used near the user and placing the device 30 not to be used far from the user. Therefore, a user of the information processing system 1 can cause only the necessary device 30 to operate. Accordingly, the user can obtain a new customer experience of being able to experience an improvement in energy saving effect of turning off the power supply of the device 30 not to be used without performing any particular work.

### Second Embodiment

In the first embodiment, the data processing apparatus 10 controls the operation state of the device 30 based on the relation between the position information of the device 30 and the user. However, when the device 30 is an acoustic device that outputs a sound and an obstacle that affects an acoustics is installed indoors, the following processing may be executed.

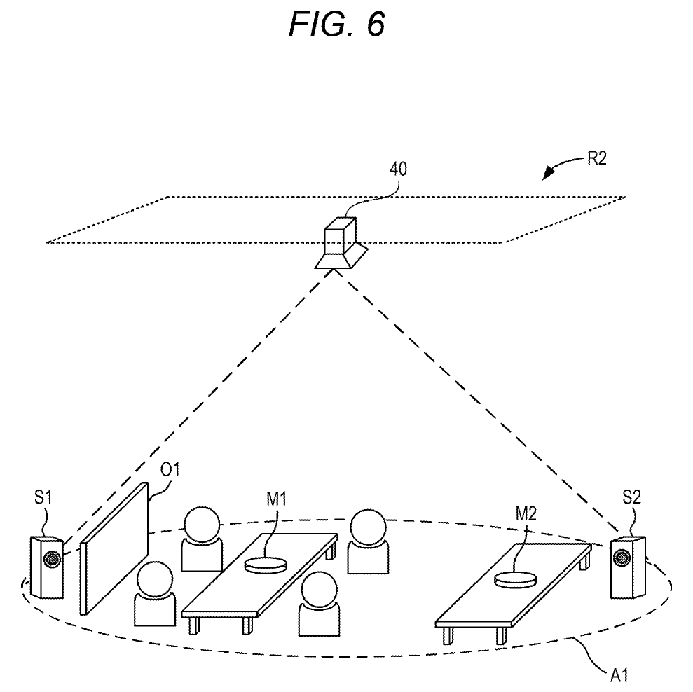

FIG. 6 is an external perspective view of a room R2 according to the second embodiment. The same configurations as those in FIG. 3 are denoted by the same reference numerals, and the description thereof is omitted. The room R2 is different from the room R1 in that the room R2 includes an obstacle O1. The obstacle O1 is large furniture, a partition, or the like.

In the present embodiment, the number of the camera 40 installed in the room R2 may be one or more.

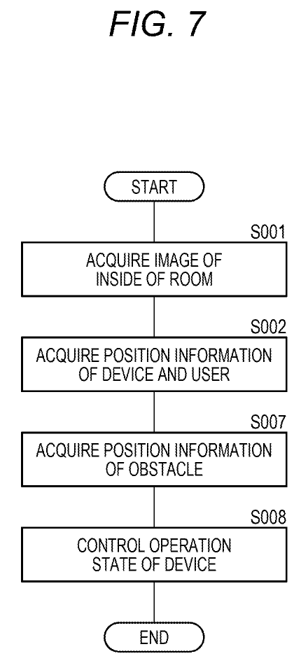

FIG. 7 is a flowchart illustrating an operation executed by the CPU 11 according to the second embodiment. Since processing of steps S001 and S002 in FIG. 7 is the same as the processing of steps S001 and S002 in FIG. 4, the description thereof will be omitted.

After acquiring the position information of the device 30 and the user in step S002, the data processing apparatus 10 further acquires position information of the obstacle O1 based on the image received from the camera 40 (S007). In this case, the data processing apparatus 10 may acquire an actual size of the obstacle O1 based on images acquired from different directions by a plurality of cameras 40 in addition to the position information of the obstacle.

Next, the data processing apparatus 10 controls the operation state of the device 30 based on a relation among the position information of the device 30, the position information of the user, which are acquired in step S002, and the position information of the obstacle O1 acquired in step S007 (S008).

In step S008, the data processing apparatus 10 determines whether the obstacle O1 that reflects or blocks a sound is installed between the positions of the device 30 and the user, and adjusts volume of the device 30 based on a determination result. Alternatively, for example, the data processing apparatus 10 may execute the determination using a training model obtained by training a relation between a shape and a size of an obstacle in a predetermined model that uses a neural network or the like. In addition, the data processing apparatus 10 may execute the determination using a training model obtained by training a relation between the size of the obstacle O1 and a distance between the position of the obstacle O1 and the position of the device 30 (hereinafter, referred to as obstacle O1-to-device 30 distance) in a predetermined model that uses a neural network or the like.

When it is determined that the obstacle O1 reflects or blocks a sound output from the speaker S1, the data processing apparatus 10 issues an instruction to the wireless device 20 to lower volume of the speaker S1 and increase volume of the speaker S2, for example. Accordingly, the user of the information processing system 1 can obtain a new customer experience that an influence on the acoustics due to the obstacle O1 can be minimized and an optimal acoustic environment in the room R2 can be automatically created.

### Third Embodiment

In the first and second embodiments, the data processing apparatus 10 controls the operation state only for the device 30 that is installed within the angle of view A1 of the camera 40 and of which the position information is acquired by the data processing apparatus 10. However, when the device 30 desired to be controlled is installed outside the angle of view of the camera 40 and position information of the device 30 cannot be acquired from the image, the following processing may be executed.

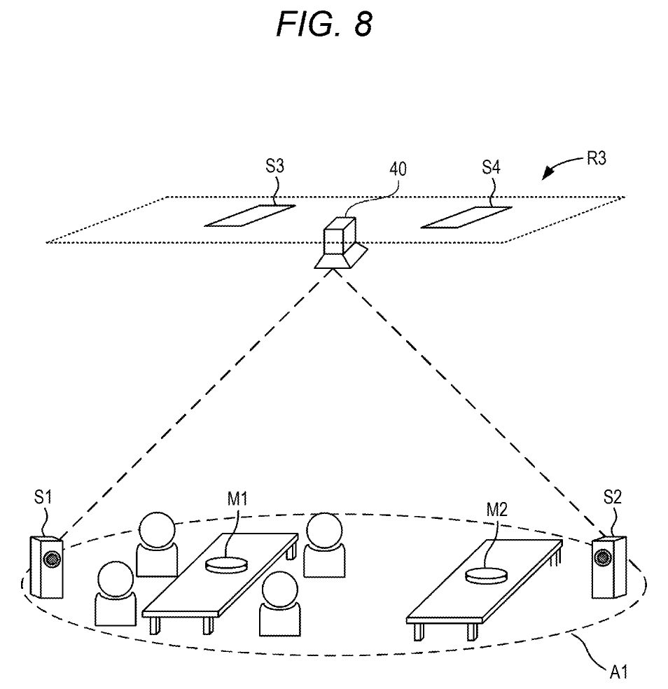

FIG. 8 is an external perspective view of a room R3 according to the third embodiment. The same configurations as those in FIG. 3 are denoted by the same reference numerals, and the description thereof is omitted. The room R3 is different from the room R1 in that the room R3 includes ceiling speakers S3 and S4. In the present embodiment, the ceiling speakers S3 and S4 are examples of the device 30 of the present disclosure.

The user of the information processing system 1 may desire to control the ceiling speakers S3 and S4 installed outside the angle of view of the camera 40 by the data processing apparatus 10. In this case, the user of the information processing system 1 may allow the data processing apparatus 10 to control operation states of the ceiling speakers S3 and S4 regardless of an installation location by previously inputting device information of the ceiling speakers S3 and S4 to the user I/F 14.

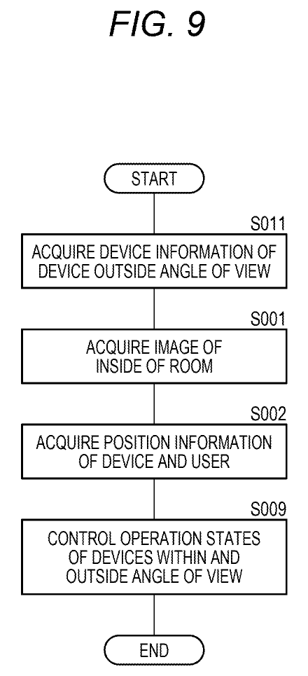

FIG. 9 is a flowchart illustrating an operation executed by the CPU 11 according to the third embodiment. Since processing of steps S001 and S002 in FIG. 9 is the same as the processing of steps S001 and S002 in FIG. 4, the description thereof will be omitted.

The data processing apparatus 10 receives an input from the user of the information processing system 1 via the user I/F 14. Specifically, the user of the information processing system 1 inputs the device information of the device 30 desired to be controlled by the data processing apparatus 10. The user determines, for example, an ID (numerical value) unique to the device 30 desired to be controlled, and inputs the unique ID as the device information. The user may further input the position information of the device 30 desired to be controlled as the device information. The data processing apparatus 10 acquires the device information of the device 30 outside the angle of view input by the user of the information processing system 1 (S011).

Next, the data processing apparatus 10 acquires an image of the room R3 from the camera 40 (S001), acquires the position information of the device 30 and the user within the angle of view based on the image (S002), and then controls operation states of both the device 30 outside the angle of view and the device 30 within the angle of view based on a relation among the position information of the device 30 outside the angle of view, the position information of the device 30 within the angle of view, and the position information of the user (S009).

As described above, in the present embodiment, even when the device 30 is not included in the image, the user of the information processing system 1 can maintain a control state by the data processing apparatus 10 by inputting the device information to the data processing apparatus 10 in advance.

### Fourth Embodiment

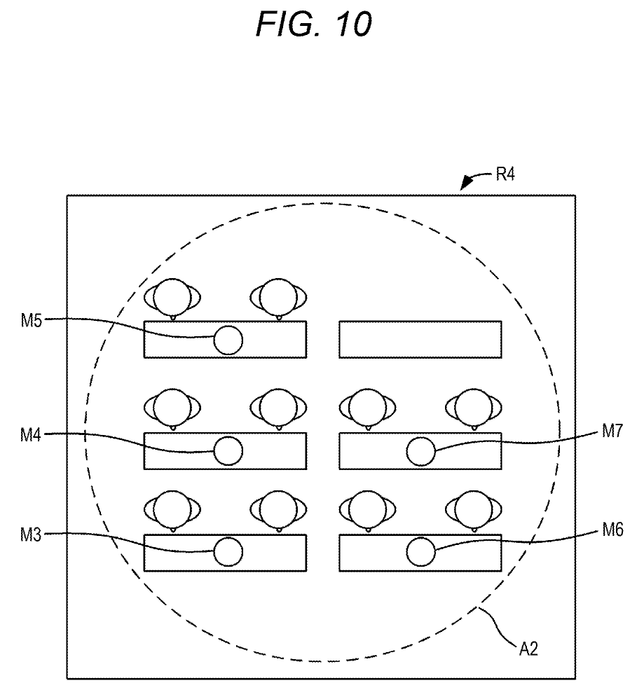

FIGS. 10, 11, and 12 are plan views of a large conference room R4 according to the fourth embodiment. Ranges indicated by broken lines in FIGS. 10, 11, and 12 are angles of view A2 to A5 of the camera 40 in the present embodiment.

In the present embodiment, the number of the camera 40 installed in the large conference room R4 may be one or more. The angles of view A2 to A5 can be optionally set by the user of the information processing system 1. In addition, a monitor (not illustrated) that projects the image captured by the camera 40 may be installed in the large conference room R4 such that the user of the information processing system 1 can visually recognize the angles of view A2 to A5 of the camera 40.

As illustrated in FIG. 10, a plurality of desktop microphones M3 to M7 are installed near the user in the large conference room R4. In the present embodiment, the desktop microphones M3 to M7 are examples of the device 30 of the present disclosure.

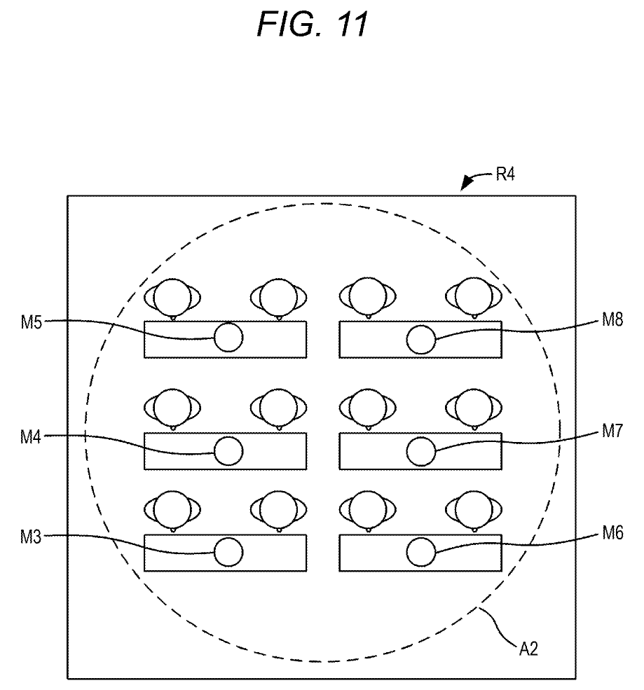

In FIG. 10, the desktop microphones M3 to M7 are in a state in which wireless connection with the wireless device 20 is already completed and operation states are controlled by the data processing apparatus 10. In such a situation, for example, it is assumed that two users have newly brought a desktop microphone M8, which is a device that is not wirelessly connected to the wireless device 20 (hereinafter, referred to as non-connected device), into the large conference room R4 and have changed a layout to that illustrated in FIG. 11. In such a case, the data processing apparatus 10 acquires position information of the desktop microphone M8 from an image newly received from the camera 40, and newly starts a control of an operation state of the desktop microphone M8 in addition to those of the desktop microphones M3 to M7 from when the position information is acquired.

In the present embodiment, the data processing apparatus 10 continuously receives images from the camera 40 in real time. That is, the data processing apparatus 10 monitors movements of the device 30 and the user in real time, and acquires the position information of the device 30 and the user. Accordingly, the user of the information processing system 1 can obtain a new customer experience that the operation state of the device 30 can be normally maintained in an optimum state for the user.

The user of the information processing system 1 may desire to return the layout of FIG. 11 to the layout of FIG. 10. In such a case, the user may move the desktop microphone M8 outside the angle of view A2 of the camera 40. At the time when the desktop microphone M8 cannot be recognized from the image received from the camera 40, the data processing apparatus 10 issues an instruction to the wireless device 20 to stop the operation of the desktop microphone M8.

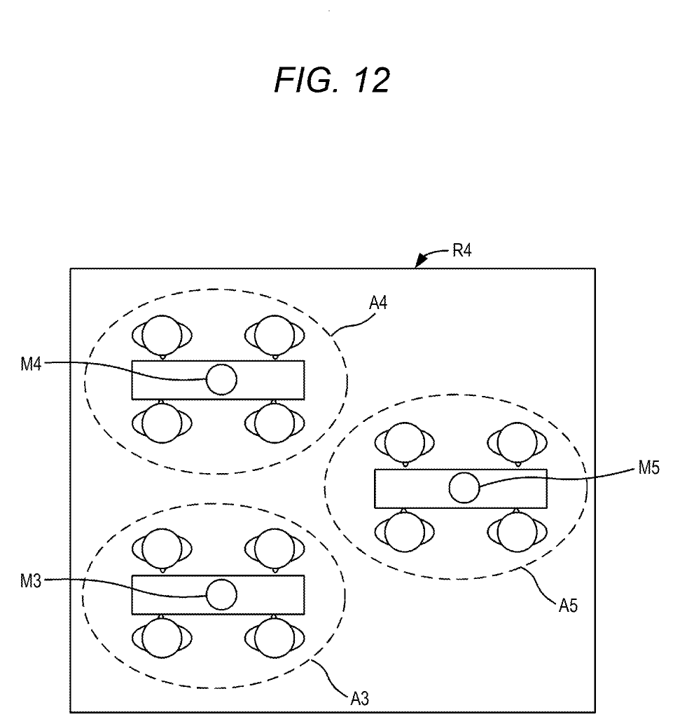

The user of the information processing system 1 may desire to change a layout of a lecture form illustrated in FIG. 11 to a layout of a discussion form illustrated in FIG. 12. In such a case, the user of the information processing system 1 sets a plurality of regions (angles of view A3, A4, and A5) from the image of the camera 40. At the same time when the angles of view A3, A4, and A5 are set, the data processing apparatus 10 switches the operation state of the device 30 to a control suitable for each of the angles of view.

As described above, in the present embodiment, the user of the information processing system 1 can easily create a space such as a small conference room by further setting the angles of view A3, A4, and A5 of small spaces from the angle of view A2 of the camera 40 without moving the room.

In the present embodiment, since the data processing apparatus 10 regards the angles of view A3, A4, and A5 as independent spaces, controls of the desktop microphones M3 to M5 are different for each of the angles of view. For example, it is assumed that a discussion of a group illustrated in the lower left (angle of view A3) of FIG. 12 ends and four users within the angle of view A3 exit the large conference room R4. In this case, when a state in which no user is detected from the angle of view A3 is maintained for a predetermined time, the data processing apparatus 10 regards that the discussion is ended, issues an instruction to the wireless device 20 to turn off a power supply of the desktop microphone M3, and cancels the control of the desktop microphone M3.

In addition, it is assumed that discussions of groups illustrated in the upper left (angle of view A4) and the right (angle of view A5) of FIG. 12 finally end and all the users exit the large conference room R4. In this case, as described above, when a state in which no user is detected from the angles of view A4 and A5 is maintained for a predetermined time, the data processing apparatus 10 issues an instruction to the wireless device 20 to turn off power supplies of the desktop microphones M4 and M5, and cancels the controls of the desktop microphones M4 and M5.

When the controls of the desktop microphones M3 to M5 are cancelled, the data processing apparatus 10 may store the control state between each of the devices 30 within the angles of view A3 to A5 and the data processing apparatus 10 immediately before the cancellation in the memory 13. Accordingly, when the users enter the large conference room R4 again and restart a discussion in the layout illustrated in FIG. 12, the data processing apparatus 10 can restart the controls of the desktop microphones M3 to M5 only by reading the previous connection state from the memory 13.

In addition, the data processing apparatus 10 may issue an instruction to the wireless device 20 to switch the desktop microphones M3 to M5 to a sleep state instead of cancelling the controls of the desktop microphones M3 to M5.

The user of the information processing system 1 may input a preferred standard pattern to the user I/F 14 in advance. Specifically, the user of the information processing system 1 inputs a pattern in which the angle of view of the camera 40 is optionally set as the standard pattern to the user I/F 14. In this case, when there is a device 30 whose control state is desired to be maintained regardless of the position of the user or the angle of view, the user of the information processing system 1 inputs device information of the device 30 to the user I/F 14. As described above, the data processing apparatus 10 that has received the input of the standard pattern starts to control the device 30 from a state of the standard pattern each time.

Accordingly, the user of the information processing system 1 can obtain a new customer experience that a conference can be immediately started without the need to wait for the processing of the data processing apparatus 10.

Finally, the description of the present embodiment should be considered to be illustrative in all respects and not restrictive. The scope of the present disclosure is indicated by the claims rather than the embodiments described above. Further, the scope of the present disclosure is intended to include all modifications within a meaning and a scope equivalent to the claims.

What is claimed is:

1. An audio device control method for an audio control apparatus, the method comprising: acquiring an image, taken by a camera, of an inside of a room including at least one audio device and at least one person; determining, from the acquired image, device position information of an audio device, from among the at least one audio device, and person position information of a person, from among the at least one person; and controlling an operation state of the audio device based on a relation between the device position information and the person position information, wherein the controlling of the operation state includes any among: powering ON and OFF the audio device; connecting and disconnecting the audio device to and from the audio control apparatus; and adjusting volume of the audio device.

2. The audio device control method according to claim 1, further comprising: determining, from the acquired image, obstacle position information of an obstacle; and wherein the relation includes a relation among the device position information, the person position information, and the obstacle position information.

3. The audio device control method according to claim 1, further comprising, in a state where the audio device cannot be recognized from the acquired image, powering OFF or disconnecting the audio device that cannot be recognized.

4. The audio device control method according to claim 1, further comprising displaying an image capturing range of the acquired image on a monitor.

5. The audio device control method according to claim 1, further comprising controlling, based on the acquired image, a different audio device that does not appear in the acquired image, but connected to the audio control apparatus, which also controls the different audio device.

6. The audio device control method according to claim 1, further comprising: recognizing, from the acquired image, a non-connected audio device that is not connected to the audio control apparatus, which also controls the non-connected audio device; connecting the non-connected audio device to the audio control apparatus; and causing the audio control apparatus to control the non-connected audio device.

7. The audio device control method according to claim 1, further comprising: determining a distance between the audio device and the person based on the device position information and the person position information, wherein the controlling of the operation state includes: powering OFF the audio device, in a state where the determined distance is greater than a predetermined distance and the audio device is powered ON; and powering ON the audio device, in a state where the determined distance is not greater than the predetermined distance and the audio device is powered OFF.

8. The audio device control method according to claim 1, wherein:
the audio control apparatus communicates with a wireless device, which communicates with the audio device,
the controlling of the operation state causes the wireless device to wirelessly connect and disconnect the audio device to and from the wireless device.

9. An audio control apparatus comprising: a camera configured to acquire an image of an inside of a room including at least one audio device and at least one person; and a processor configured to: acquire, from the acquired image from the camera, device position information of an audio device, from among the at least one audio device, and person position information of a person, from among the at least one person; and control an operation state of the audio device based on a relation between the device position information and the person position information, wherein the control of the operation state includes any among: powering ON and OFF the audio device; connecting and disconnecting the audio device to and from the audio control apparatus; and adjusting volume of the audio device.

10. The audio control apparatus according to claim 9, wherein the processor is further configured to: determine, from the acquired image, obstacle position information of an obstacle, wherein the relation further includes a relation among the device position information, the person position information, and the obstacle position information.

11. The audio control apparatus according to claim 9, wherein, in a state where the audio device cannot be recognized from the acquired image, the processor is further configured to power OFF or disconnect the audio device that cannot be recognized.

12. The audio control apparatus according to claim 9, further comprising: a monitor, wherein the processor is further configured to cause an image capturing range of the acquired image to be displayed on the monitor.

13. The audio control apparatus according to claim 9, wherein the processor is further configured to control, based on the acquired image, a different audio device that does not appear in the acquired image, but connected to the audio control apparatus, which also controls the different device.

14. The audio control apparatus according to claim 9, wherein the processor is configured to: recognize, from the acquired image, a non-connected audio device that is not connected to the audio control apparatus, which also controls the non-connected audio device; connect the non-connected audio device to the audio control apparatus; and control the non-connected audio device.

15. The audio control apparatus according to claim 9, wherein the processor is further configured to: determine a distance between the audio device and the person based on the device position information and the person position information, wherein the control of the operation state includes: powering OFF the audio device, in a state where the determined distance is greater than a predetermined distance and the audio device is powered ON; and powering ON the audio device, in a state where the determined distance is not greater than the predetermined distance and the audio device is powered OFF.

16. The audio control apparatus according to claim 9, wherein: the audio control apparatus communicates with a wireless device, which communicates with the audio device, the processor controls the operation state by causing the wireless device to wirelessly connect and disconnect the audio device to and from the wireless device.

17. An audio device control system comprising: an audio device; and an audio device control apparatus comprising: a camera configured to acquire an image of an inside of a room; and a processor configured to: acquire, from the acquired image, device position information of an audio device and person position information of a person; and control an operation state of the audio device based on a relation between the device position information and the person position information, wherein the operation state includes any among: powering ON and OFF the audio device; connecting and disconnecting the audio device to and from the control apparatus; and adjusting volume of the audio device.

18. The audio control system according to claim 17, wherein the processor is further configured to: determine a distance between the audio device and the person based on the device position information and the person position information, wherein the control of the operation state includes: powering OFF the audio device, in a state where the determined distance is greater than a predetermined distance and the audio device is powered ON; and powering ON the audio device, in a state where the determined distance is not greater than the predetermined distance and the audio device is powered OFF.

19. The audio control system according to claim 17, further comprising: a wireless device that communicates with the audio control apparatus and the audio device, wherein the processor controls the operation state by causing the wireless device to wirelessly connect and disconnect the audio device to and from the wireless device.
